(19) United States
(12) Patent Application Publication
(10) Pub. No.: US 2022/0191072 A1
(43) Pub. Date: Jun. 16, 2022

(54) AUTOMOBILE

(71) Applicant: KOITO MANUFACTURING CO., LTD., Minato-ku, Tokyo (JP)

(72) Inventor: Hiroto TAHARA, Shizuoka-shi, Shizuoka (JP)

(73) Assignee: KOITO MANUFACTURING CO., LTD., Minato-ku, Tokyo (JP)

(21) Appl. No.: 17/484,673

(22) PCT Filed: Mar. 3, 2020
(86) PCT No.: PCT/JP2020/008926

§ 371 Date: Sep. 24, 2021

(30) Foreign Application Priority Data
Mar. 26, 2019 (JP) 2019-058307

(51) Int. Cl. H04L 25/03; H04N 7/18

(52) U.S. Cl. CPC H04L 25/03872; H04N 7/18

(57) ABSTRACT

An automobile includes an automotive lamp and an in-vehicle controller. A sensor generates image data. An encoder divides the image data into multiple data frames, and encodes the data frame thus divided. A scrambler scrambles the data frame thus encoded using a reproducible pseudo-random signal. A serializer converts the output of the scrambler into serial data. A transmitter transmits the serial data to the in-vehicle controller via a cable.

### BACKGROUND

### 1. Technical Field

The present disclosure relates to a communication system in an automobile.

### 2. Description of the Related Art

In order to support autonomous driving or automatic control of the light distribution of a headlamp, an object identification system is employed for sensing the position and the kind of an object that exists in the vicinity of a vehicle. The object identification system includes a sensor and a processing device configured to analyze the output of the sensor. As such a sensor, a selection is made from among a camera, LiDAR (Light Detection and Ranging, Laser Imaging Detection and Ranging), millimeter-wave radar, ultrasonic sonar, etc., giving consideration to the usage, required precision, and cost.

When image data generated by such a sensor is transmitted in a vehicle, noise is emitted from a cable. In particular, when there is a small difference between transmitted images, or when the same image data is repeatedly transmitted, serial data transmitted via a cable exhibits periodicity, leading to a problem of noise concentrated in a particular spectrum.

In conventional board-to-board communication in a vehicle, in order to prevent noise emission from such a cable, there is a need to employ a shielded cable, leading to a problem of an increased cost.

### SUMMARY

The present disclosure has been made in view of such a situation.

An embodiment of the present disclosure relates to a lamp system or an automobile. The system/automobile includes an automotive lamp and an in-vehicle controller structured to receive image data generated by the automotive lamp via a cable. The automotive lamp includes: a sensor structured to generate image data; an encoder structured to divide the image data into multiple data frames, and to encode the data frame; a scrambler structured to scramble the data frame thus encoded using a reproducible pseudo-random signal; a serializer structured to convert the output of the scrambler into serial data; and a transmitter structured to transmit the serial data to the in-vehicle controller via the cable. The in-vehicle controller includes: a receiver structured to receive the serial data from the automotive lamp via the cable; a deserializer structured to convert the serial data received by the receiver into data frame in the form of parallel data; and a descrambler structured to descramble the output of the deserializer using a reproducible pseudo-random signal.

It is to be noted that any arbitrary combination or rearrangement of the above-described structural components and so forth is effective as and encompassed by the present embodiments. Moreover, this summary does not necessarily describe all necessary features so that the disclosure may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram showing an automobile according to an embodiment;

FIG. 2 is a block diagram concerning the transmission of image data between an automotive lamp and an in-vehicle controller.

FIG. 3 is a block diagram showing a scrambler and a descrambler;

FIG. 4 is a diagram showing a structure of a frame including data frame FD.

FIG. 5A is a diagram showing the spectrum of emitted noise in a conventional automobile, and FIG. 5B is a diagram showing the spectrum of emitted noise in an automobile according to an embodiment.

### DETAILED DESCRIPTION

### Overview of Embodiments

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “one embodiment” may be used herein to refer to a single embodiment or multiple embodiments of the disclosure.

An automobile according to one embodiment includes an automotive lamp and an in-vehicle controller structured to receive image data generated by the automotive lamp via a cable. The automotive lamp includes: a sensor structured to generate image data; an encoder structured to divide the image data into multiple data frames, and to encode the data frame; a scrambler structured to scramble the data frame thus encoded using a reproducible pseudo-random signal; a serializer structured to convert the output of the scrambler into serial data; and a transmitter structured to transmit the serial data to the in-vehicle controller via the cable. The in-vehicle controller includes: a receiver structured to receive the serial data from the automotive lamp via the cable; a deserializer structured to convert the serial data received by the receiver into data frame in the form of parallel data; and a descrambler structured to descramble the output of the deserializer using a reproducible pseudo-random signal.

Even in a case in which the original data exhibits monotonicity, with such an arrangement in which the original data is scrambled using a pseudo-random signal, this disturbs the monotonicity, which allows the spectrum to be diffused. This allows a noise countermeasure to be supported with a reduced cost.

With one embodiment, the scrambler may include: a first pseudo-random signal generator structured to generate the pseudo-random signal; and a first XOR gate structured to generate the exclusive-OR of the pseudo-random signal and the data frame. The descrambler may include: a second pseudo-random signal generator structured to generate the pseudo-random signal; and a second XOR gate structured to generate the exclusive-OR of the pseudo-random signal and the data frame.

With one embodiment, the first pseudo-random signal generator may determine a seed (initial value) for generating the pseudo-random signal based on a part of the image data.

With one embodiment, the first pseudo-random signal generator may change the seed of the pseudo-random signal for every frame.

An automotive lamp according to one embodiment includes: a lamp; a sensor structured to generate image data; an encoder structured to divide the image data into multiple data frames, and to encode the data frame thus divided; a scrambler structured to scramble the output data of the encoder using a reproducible pseudo-random signal; a serializer structured to convert the output of the scrambler into serial data; and a transmitter structured to transmit the serial data thus scrambled to an in-vehicle controller via a cable.

### Embodiments

Description will be made below regarding preferred embodiments with reference to the drawings. The same or similar components, members, and processes are denoted by the same symbols, and redundant description thereof will be omitted as appropriate. The embodiments have been described for exemplary purposes only, and are by no means intended to restrict the present disclosure and the present invention. Also, it is not necessarily essential for the present disclosure and the present invention that all the features or a combination thereof be provided as described in the embodiments.

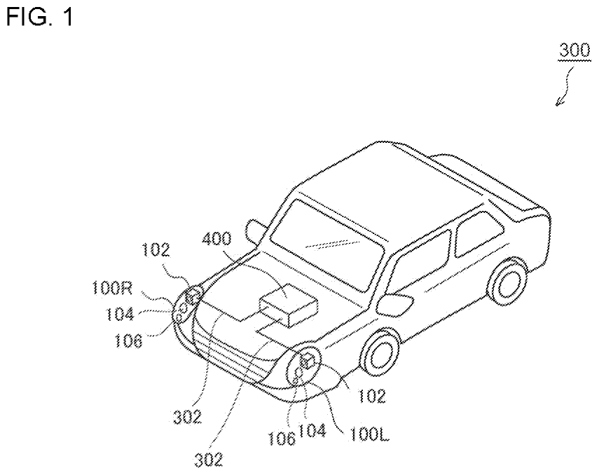

FIG. 1 is a diagram showing an automobile 300 according to one embodiment. The automobile 300 includes automotive lamps 100L and 100R and an in-vehicle controller (ECU: Electronic Control Unit) 400. The automotive lamps 100L and 100R each include light sources that form a high-beam lamp 104 and a low-beam lamp 106, a lighting circuit for each light source, a heatsink, and the like as its built-in components. Furthermore, at least one from among the automotive lamps 100L and 100R (both the automotive lamps 100L and 100R in this example) includes a sensor 102. The sensor 102 is configured as a visible-light camera, infrared camera, TOF camera, or the like that generates image data. There may be a difference in the kind of the sensor between the left and right automotive lamps 100L and 100R. The automotive lamp 100 transmits image data generated by the sensor 102 to the in-vehicle controller 400 via a cable 302.

It should be noted that the automotive lamp 100 and the in-vehicle controller 400 are coupled via an interface such as a Controller Area Network (CAN), Local Interconnect Network (LIN), or the like in addition to the cable 302. This allows other kinds of data and control signals to be transmitted and received in addition to the image data.

The in-vehicle controller 400 supports autonomous driving control based on the image data received from the automotive lamp 100. Alternatively, the image data may be used for an automatic light distribution control operation of the in-vehicle controller 400.

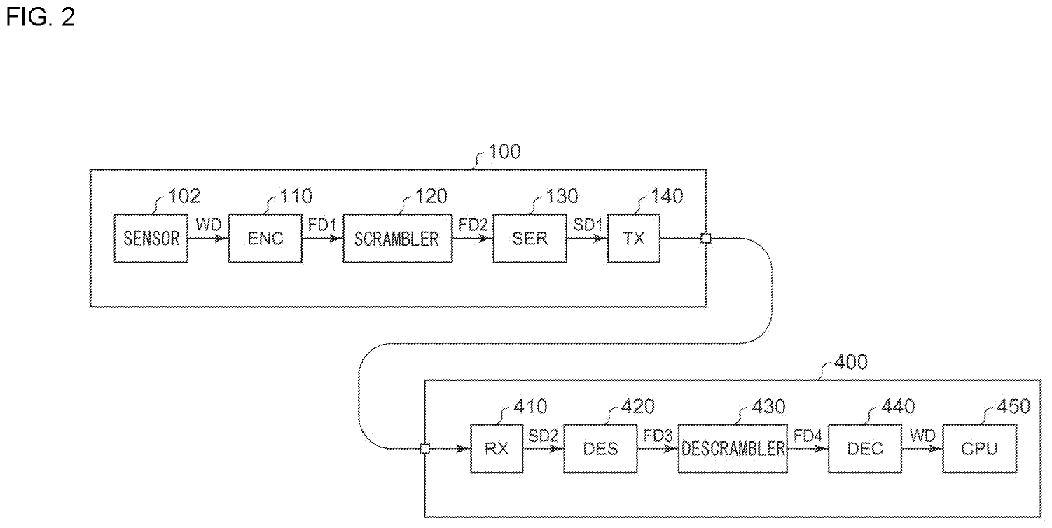

FIG. 2 is a block diagram concerning the transmission of image data between the automotive lamp 100 and the in-vehicle controller 400.

The automotive lamp 100 includes an encoder 110, a scrambler 120, a serializer 130, and a transmitter 140, in addition to the sensor 102. The functions of the encoder 110, the scrambler 120, the serializer 130, and the transmitter 140 can be implemented in a Field Programmable Gate Array (FPGA), Application Specific Integrated Circuit (ASIC), or the like.

The encoder 110 divides image data Si generated by the sensor 102 into multiple data frames, and encodes the data frame thus divided. It should be noted that the “data frame” represents a frame in serial data transmission, and that it is unrelated to a single frame of the image data Si. For example, the encoder 110 divides the image data Si into multiple items of word data WD each configured as 8-bit data. Each word data WD is encoded using 8b10b encoding. Instead of the 8b10b encoding, other kinds of encoding methods may be employed. Subsequently, a predetermined number of items of word data are bundled as an item of data frame (payload) FD1. The length of the data frame FD1 is not restricted in particular. Rather, the length of the data frame FD1 may preferably be determined based on the content of the data to be transmitted or the bus standard. For example, in a case in which the bus is designed with a bus width of 64 bits and with a burst length of 256, each data frame may include 1024 (=8×256) words.

The scrambler 120 scrambles the data frame FD1 thus encoded using a reproducible pseudo-random signal. The serializer 130 converts the output FD2 of the scrambler 120 into serial data SD1. The transmitter 140 transmits the serial data SD1 to the in-vehicle controller 400 via the cable 302.

The in-vehicle controller 400 includes a receiver 410, a deserializer 420, a descrambler 430, a decoder 440, and a Central Processing Unit (CPU) 450. The receiver 410 receives the serial data SD2 from the automotive lamp 100 via the cable 302. The deserializer 420 converts the serial data SD2 received by the receiver 410 into data frame FD3 in the form of parallel data.

The descrambler 430 descrambles the data frame FD3 configured as parallel data using a reproducible pseudo-random signal. The pseudo-random signal used for the descrambling is the same as the pseudo-random signal used for the scrambling.

The decoder 440 decodes the data frame FD4 after the descrambling by the descrambler 430, so as to extract the multiple items of word data WD included in the data frame FD4. The decoding processing provided by the decoder 440 is the reverse of the encoding processing provided by the encoder 110. Specifically, the decoder 440 divides the data frame FD4 in units of 10-bit data, and decodes the data frame thus divided using 8b10b decoding, so as to extract the word data WD in the form of 8-bit data.

The original image data is reconstructed based on the multiple items of word data WD. The CPU 450 supports an object detection operation, object identification operation, etc., based on the image data, and generates information necessary for autonomous driving or the control of light distribution of a lamp.

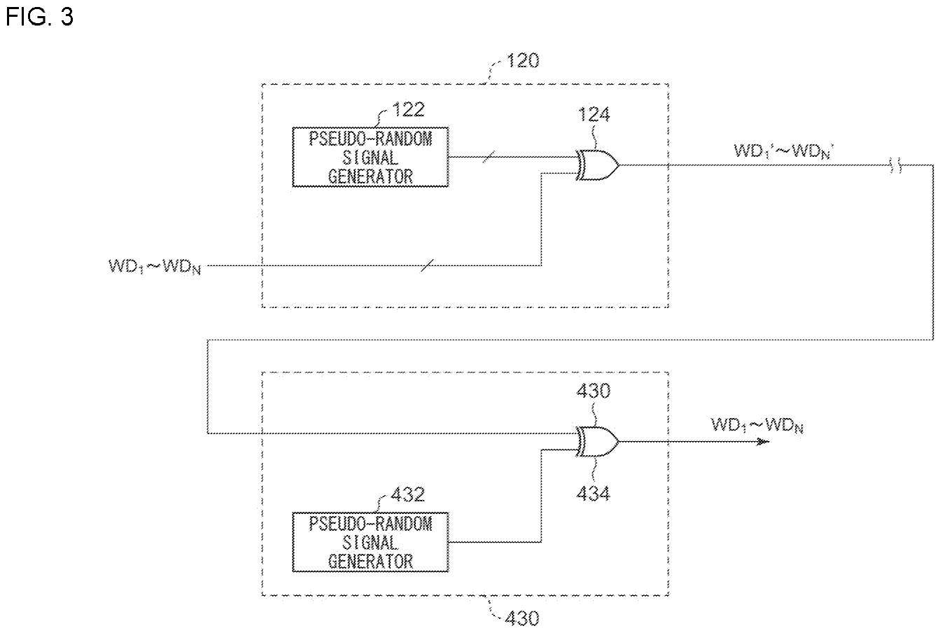

FIG. 3 is a block diagram showing the scrambler 120 and the descrambler 430. The scrambler 120 includes a first pseudo-random signal generator 122 and a first XOR gate 124. The first pseudo-random signal generator 122 generates a pseudo-random signal PRBS1. The configuration of the first pseudo-random signal generator 122 is not restricted in particular. Rather, known techniques may be employed. The first XOR gate 124 generates the exclusive-OR of the pseudo-random signal PRBS1 and the data frame FD1.

The descrambler 430 includes a second pseudo-random signal generator 432 and a second XOR gate 434. The second pseudo-random signal generator 432 generates a pseudo-random signal PRBS2. The pseudo-random signal PRBS2 matches the pseudo-random signal PRBS1 used in the scrambler 120. The first pseudo-random signal generator 122 and the second pseudo-random signal generator 432 have the same configuration. At the beginning of the data frame, the second pseudo-random signal generator 432 is reset, and a common seed (initial value) is supplied.

Preferably, it is effective for the seeds to be supplied for the first pseudo-random signal generator 122 and the second pseudo-random signal generator 432 to be changed for every frame. This allows the periodicity of the serial data transmitted via the cable 302 to be further disturbed.

The first pseudo-random signal generator 122 may determine the seed of the pseudo-random signal PRBS1 to be used for the scrambling of the current data frame based on a part of the image data, e.g., a part of the immediately previous data frame. In the same manner, the second pseudo-random signal generator 432 may determine the seed of the pseudo-random signal PRBS2 to be used for the descrambling of the current data frame based on a corresponding part of the immediately previous descrambled data frame.

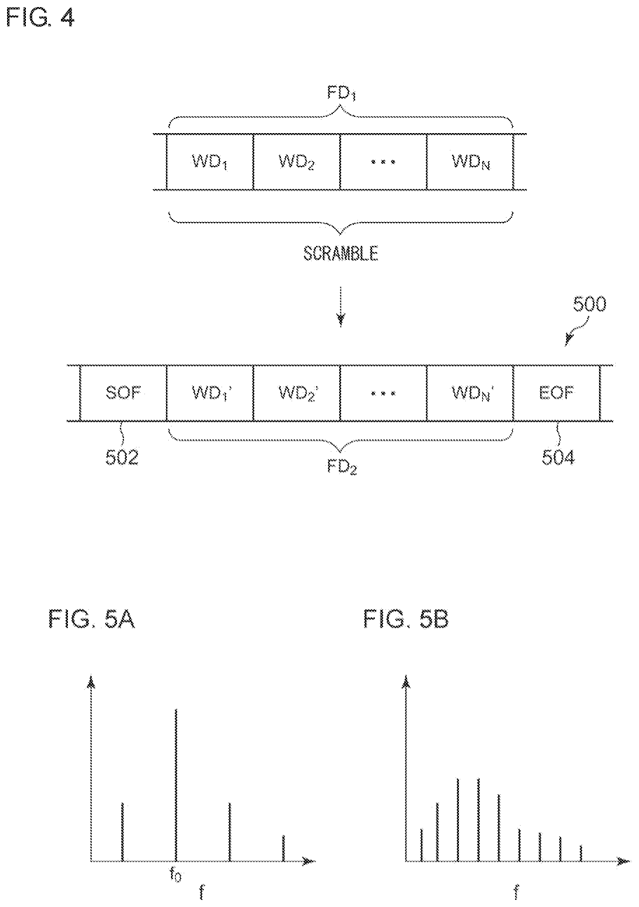

FIG. 4 is a diagram showing a structure of a frame 500 containing data frame FD. The frame 500 includes a preamble 502 indicating the beginning of the frame 500 (SOF: Start Of Frame), a postamble 504 indicating the end of the frame 500 (EOF: End Of Frame), and the data frame FD contained between the preamble 502 and the postamble 504. Only the data frame FD is scrambled, and the preamble 502 and the postamble 504 are added to the scrambled data frame FD′.

The above is the configuration of the automotive lamp 100. Next, description will be made regarding the operation thereof. FIG. 5A is a diagram showing a spectrum of emitted noise that occurs in a conventional automobile. FIG. 5B is a diagram showing a spectrum of emitted noise that occurs in the automobile 300 according to the embodiment.

Description will be made referring to FIG. 5A. In a case in which the scrambling is not carried out, when there is a small change between multiple items of image data or when the same image data is repeatedly transmitted, the serial data transmitted via the cable 302 exhibits periodicity, leading to a problem of noise concentrated in a particular spectrum f₀. Accordingly, in order to satisfy the Electromagnetic Interference (EMI) standards required for in-vehicle devices, there is a need to provide a countermeasure such as the use of a shielded cable or the like.

Description will be made referring to FIG. 5A. In the automobile 300 according to the embodiment in which the serial data to be transmitted between the automotive lamp 100 and the in-vehicle controller 400 is scrambled based on a pseudo-random signal, this allows the peak spectrum to be diffused. This allows the noise countermeasure to be simplified. For example, such an arrangement is capable of satisfying the EMI standards even in a case in which a non-shielded, low-cost cable is employed.

Description has been made above regarding the present invention with reference to the embodiments. The above-described embodiments have been described for exemplary purposes only, and are by no means intended to be interpreted restrictively. Rather, it can be readily conceived by those skilled in this art that various modifications may be made by making various combinations of the aforementioned components or processes, which are also encompassed in the technical scope of the present invention. Description will be made below regarding such modifications.

Also, the seed used in the scrambler 120 may be transmitted such that it is included in the preamble 502. The descrambler 430 may extract the seed from the preamble 502 so as to descramble the payload (data frame) that follows the preamble 502.

In this case, the seed to be used for the scrambling of a given item of data frame (payload) may be generated based on the data frame itself. For example, a bit included at a predetermined position of the data frame may be employed as the seed. Also, a pixel value may be selected at random from the data frame.

Alternatively, the seed may be generated by a pseudo-random generator that differs from the first pseudo-random signal generator 122.

While the preferred embodiments of the present disclosure have been described using specific terms, such description is for illustrative purposes only, and it is to be understood that changes and variations may be made without departing from the spirit or scope of the appended claims.

What is claimed is:

1. An automobile comprising:
an automotive lamp; and
an in-vehicle controller structured to receive image data generated by the automotive lamp via a cable, wherein the automotive lamp comprises:
a sensor structured to generate image data;
an encoder structured to divide the image data into a plurality of data frames, and to encode the data frame;
a scrambler structured to scramble the data frame thus encoded using a reproducible pseudo-random signal;
a serializer structured to convert an output of the scrambler into serial data; and
a transmitter structured to transmit the serial data to the in-vehicle controller via the cable,
and wherein the in-vehicle controller comprises:
a receiver structured to receive the serial data from the automotive lamp via the cable;
a deserializer structured to convert the serial data received by the receiver into data frame in the form of parallel data; and
a descrambler structured to descramble an output of the deserializer using a reproducible pseudo-random signal.

2. The automobile according to claim 1, wherein the scrambler comprises:
a first pseudo-random signal generator structured to generate the pseudo-random signal; and
a first XOR gate structured to generate an exclusive-OR of the pseudo-random signal and the data frame,
wherein the descrambler comprises:
a second pseudo-random signal generator structured to generate the pseudo-random signal; and
a second XOR gate structured to generate an exclusive-OR of the pseudo-random signal and the data frame.

3. The automobile according to claim 2, wherein the first pseudo-random signal generator determines a seed for generating the pseudo-random signal based on a part of the image data.

4. The automobile according to claim 2, wherein the first pseudo-random signal generator changes the seed of the pseudo-random signal for every frame.

5. An automotive lamp comprising:
a lamp;
a sensor structured to generate image data;
an encoder structured to divide the image data into a plurality of data frames, and to encode the data frame thus divided;
a scrambler structured to scramble the data frame thus encoded using a reproducible pseudo-random signal;
a serializer structured to convert an output of the scrambler into serial data; and
a transmitter structured to transmit the serial data thus scrambled to an in-vehicle controller via a cable.
